(19) United States
(12) Patent Application Publication
(10) Pub. No.: US 2023/0210062 A1
(43) Pub. Date: Jul. 6, 2023

(54) GREENHOUSE PLANT GROWTH MONITORING SYSTEM

(71) Applicant: Sinowell (Shanghai) Co., Ltd., Shanghai (CN)

(72) Inventors: Jia LUO, Shanghai (CN); Yunfei DUAN, Shanghai (CN); Junrong YI, Shanghai (CN); Jiezhao WANG, Shanghai (CN)

(21) Appl. No.: 17/813,496

(22) Filed: Jul. 19, 2022

Related U.S. Application Data
(63) Continuation of application No. PCT/CN2022/087062, filed on Apr. 15, 2022.

(30) Foreign Application Priority Data
Dec. 31, 2021 (CN) 202111667036.1
Dec. 31, 2021 (CN) 202123440436.7

(51) Int. Cl. A01G 9/24; G06F 3/14

(52) U.S. Cl. CPC A01G 9/246; G06F 3/14; A01G 9/249

(57) ABSTRACT

Provided is a greenhouse plant growth monitoring system. The system includes a master controller, an external monitoring module, an internal monitoring module and an external circulation device. The external monitoring module is disposed outside a greenhouse, and is configured to monitor an external environment of the greenhouse and output an external environment monitoring signal. The internal monitoring module is disposed inside the greenhouse, and is configured to monitor an internal environment of the greenhouse and output an internal environment monitoring signal. The master controller includes an external environment signal input terminal, an internal environment signal input terminal and an external circulation control signal output terminal. The external environment signal input terminal is connected to an external monitoring signal output terminal of the external monitoring module. The internal environment signal input terminal is connected to an internal monitoring signal output terminal of the internal monitoring module.

### CROSS-REFERENCE TO RELATED APPLICATION

This is a continuation of International Patent Application No. PCT/CN2022/087062, filed on Apr. 15, 2022, which is based on and claims priority to Chinese Patent Applications No. 202111667036.1 and 202123440436.7 filed with the China National Intellectual Property Administration (CNIPA) on Dec. 31, 2021, the disclosures of which are incorporated herein by reference in their entirety.

### TECHNICAL FIELD

The present disclosure relates to a planting field, for example, to a greenhouse plant growth monitoring system.

### BACKGROUND

Greenhouse plants are easily affected by the environment, and thus a suitable growing environment is beneficial to the cultivation of the greenhouse plants. The change in temperature and humidity in the growing environment is usually the main factor of affecting the plant growth.

In the related art, the temperature and the humidity in the internal environment where the greenhouse plants grow are monitored by means of mounting a temperature sensor and a humidity sensor, and the temperature and the humidity in the environment are adjusted according to the growth state of the greenhouse plants. However, for the greenhouse plants planted in a tent, monitoring of the environment only inside the tent makes environment parameters too simplistic, leading to the limitation in the growth of the greenhouse plants.

### SUMMARY

The present disclosure provides a greenhouse plant growth monitoring system to scientifically monitor an internal environment and an external environment for the growth of the greenhouse plants, improving the quality, overall yield and profitability of greenhouse plants.

The present disclosure provides a greenhouse plant growth monitoring system. The system includes a master controller, an external monitoring module, an internal monitoring module and an external circulation device.

The external monitoring module is disposed outside a greenhouse, and is configured to monitor an external environment of the greenhouse and output an external environment monitoring signal.

The internal monitoring module is disposed inside the greenhouse, and is configured to monitor an internal environment of the greenhouse and output an internal environment monitoring signal.

The master controller includes an external environment signal input terminal, an internal environment signal input terminal and an external circulation control signal output terminal. The external environment signal input terminal is connected to an external monitoring signal output terminal of the external monitoring module. The internal environment signal input terminal is connected to an internal monitoring signal output terminal of the internal monitoring module. The external circulation control signal output terminal is electrically connected to a control terminal of the external circulation device. The master controller is configured to control the external circulation device to be turned on or off according to the external environment monitoring signal and the internal environment monitoring signal.

The external circulation device is configured to control external circulation of air in the plant growth greenhouse.

### BRIEF DESCRIPTION OF DRAWINGS

FIG. 1 is a structure diagram of a greenhouse plant growth monitoring system provided by an embodiment of the present disclosure;

FIG. 2 is a structure diagram of another greenhouse plant growth monitoring system provided by an embodiment of the present disclosure;

FIG. 3 is a structure diagram of another greenhouse plant growth monitoring system provided by an embodiment of the present disclosure;

FIG. 4 is a diagram illustrating a working principle of a first speed governing circuit in a greenhouse plant growth monitoring system provided by an embodiment of the present disclosure;

FIG. 5 is a diagram illustrating a working principle of a second speed governing circuit in a greenhouse plant growth monitoring system provided by an embodiment of the present disclosure;

FIG. 6 is a diagram illustrating a working principle of a dimming circuit in a greenhouse plant growth monitoring system provided by an embodiment of the present disclosure;

FIG. 7 is a structure diagram of another greenhouse plant growth monitoring system provided by an embodiment of the present disclosure;

FIG. 8 is a diagram illustrating a working principle of a driving power supply in a greenhouse plant growth monitoring system provided by an embodiment of the present disclosure; and

FIG. 9 is a structure diagram of a master control circuit of a greenhouse plant growth monitoring system provided by an embodiment of the present disclosure.

### DETAILED DESCRIPTION

The present disclosure is described below in conjunction with drawings and embodiments. The specific embodiments set forth below are intended to explain the preset application. For ease of description, only parts related to the present disclosure are illustrated in the drawings.

Terms used in embodiments of the present disclosure are intended only to describe embodiments and not to limit the present disclosure. Nouns of locality such as “above”, “below”, “left” and “right” in the embodiments of the present disclosure are described from angles shown in the drawings and are not to be construed as limiting the embodiments of the present disclosure. Additionally, in the context, when an element is formed “above” or “below” another element, the element can not only be directly formed “above” or “below” the another element but also be indirectly formed “above” or “below” the another element via an intermediate element. Terms such as “first” and “second” are used only for the purpose of description to distinguish between different components and not to indicate any order, quantity or importance. For those of ordinary skill in the art, meanings of the preceding terms can be understood according to situations in the present disclosure.

The technical solutions of the present disclosure are described hereinafter in conjunction with drawings and embodiments.

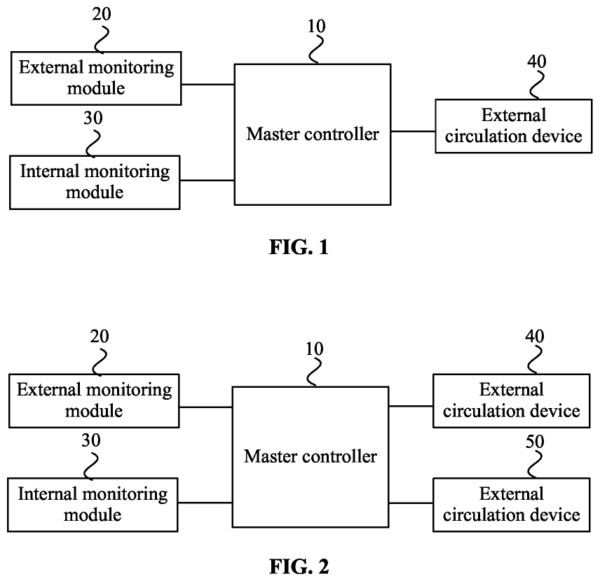

FIG. 1 is a structure diagram of a greenhouse plant growth monitoring system provided by an embodiment of the present disclosure. Referring to FIG. 1, the monitoring system includes a master controller 10, an external monitoring module 20, an internal monitoring module 30 and an external circulation device 40. The external monitoring module 20 is disposed outside a greenhouse, and is configured to monitor an external environment of the greenhouse and output an external environment monitoring signal. The internal monitoring module 30 is disposed inside the greenhouse, and is configured to monitor an internal environment of the greenhouse and output an internal environment monitoring signal. The master controller 10 includes an external environment signal input terminal, an internal environment signal input terminal and an external circulation control signal output terminal. The external environment signal input terminal is connected to an external monitoring signal output terminal of the external monitoring module 20. The internal environment signal input terminal is connected to an internal monitoring signal output terminal of the internal monitoring module 30. The external circulation control signal output terminal is electrically connected to a control terminal of the external circulation device. The master controller 10 is configured to control the external circulation device 40 to be turned on or off according to the external environment monitoring signal and the internal environment monitoring signal. The external circulation device 40 is configured to control external circulation of air in the plant growth greenhouse.

The external monitoring module 20 is mounted in the external environment of the greenhouse to monitor the external environment of the greenhouse. The external monitoring module 20 may be fixedly or moveably mounted in the external environment to monitor relevant environment parameters in different positions in the external environment. Environment parameters of the external environment of the greenhouse includes the external environment's temperature, humidity, oxygen content percentage, light intensity, carbon dioxide concentration, air speed, air volume, air flow rate and the like. This embodiment does not limit the type and the number of the environment parameters. Exemplarily, the external monitoring module 20 is fixedly mounted on an outer side of the greenhouse tent close to a vent. The external monitoring module 20 may monitor information such as a temperature, a humidity, an oxygen content percentage and a light intensity near the vent in real time. The external monitoring module 20 monitors a temperature of 16° C., a humidity of 80%, an oxygen content percentage of 60%, and a light intensity of 1 wlx near the vent in the early morning. According to the monitored relevant environment parameters, the external monitoring module 20 can output the external environment monitoring signal to the master controller 10. The light intensity of the external environment is generally referred to as a luminous flux under the solar radiation.

The internal monitoring module 30 is mounted in the internal environment of the greenhouse to monitor the internal environment of the greenhouse. The internal monitoring module 30 may be fixedly or moveably mounted in the internal environment to monitor relevant environmental parameters in different positions in the internal environment. Environment parameters of the greenhouse internal environment includes the internal environment's temperature, humidity, oxygen content percentage, light intensity, carbon dioxide concentration, air speed, air volume, air flow rate and the like. This embodiment does not limit the type and the number of the environment parameters. Exemplarily, the internal monitoring module 30 is mounted inside the greenhouse tent. The position of the internal monitoring module 30 may be correspondingly adjusted according to a position of an internal monitoring point of the greenhouse tent, and the number of internal monitoring points is not limited in this embodiment. The internal monitoring module 30 monitors information such as a temperature, a humidity, an oxygen content percentage and a light intensity in real time. The internal monitoring module 30 monitors a temperature of 25° C., a humidity of 60%, an oxygen content percentage of 80%, and a light intensity of 2 wlx inside the tent at twelve noon. According to the monitored real-time relevant environment parameters, the internal monitoring module 30 can output the internal environment monitoring signal to the master controller 10.

The master controller 10 determines whether to turn on or off the external circulation device 40 according to the received external environment monitoring signal and the received internal environment monitoring signal. Exemplarily, the external environment monitoring signal output from the external monitoring module 20 is transmitted to the external environment signal input terminal, the internal environment monitoring signal output from the internal monitoring module 30 is transmitted to the internal environment signal output terminal, and the master controller 10 judges whether the external circulation device 40 needs to be turned on. In a case where the external circulation device 40 needs to be turned on, the master controller 10 outputs an external circulation adjustment signal to the control terminal of the external circulation device 40 to turn on the external circulation device 40. The external circulation device 40 includes a ventilation fan 41. The ventilation fan 41 in the external circulation device 40 exchanges air in the plant growth greenhouse with external air so as to achieve the circulation of the air in the greenhouse and the external air.

FIG. 2 is a structure diagram of another greenhouse plant growth monitoring system provided by an embodiment of the present disclosure. Referring to FIG. 2, the greenhouse plant growth monitoring system may also include an internal circulation device 50. The master controller 10 also includes an internal circulation control signal output terminal. The internal circulation control signal output terminal is electrically connected to a control terminal of the internal circulation device 50. The master controller 10 is also configured to control the internal circulation device to be turned on or off according to the external environment monitoring signal and the internal environment monitoring signal.

The master controller 10 determines whether to turn on or off the internal circulation device 50 according to the output external environment monitoring signal and the output internal environment monitoring signal. The master controller 10 judges whether the internal circulation device 50 needs to be turned on. In a case where the internal circulation device 50 needs to be turned on, the master controller 10 outputs an internal circulation adjustment signal to the control terminal of the internal circulation device 50 to turn on the internal circulation device 50. The internal circulation device 50 includes a circulation fan 51. The circulation fan 51 in the internal circulation device 50 is configured to accelerate airflow circulation in the internal environment.

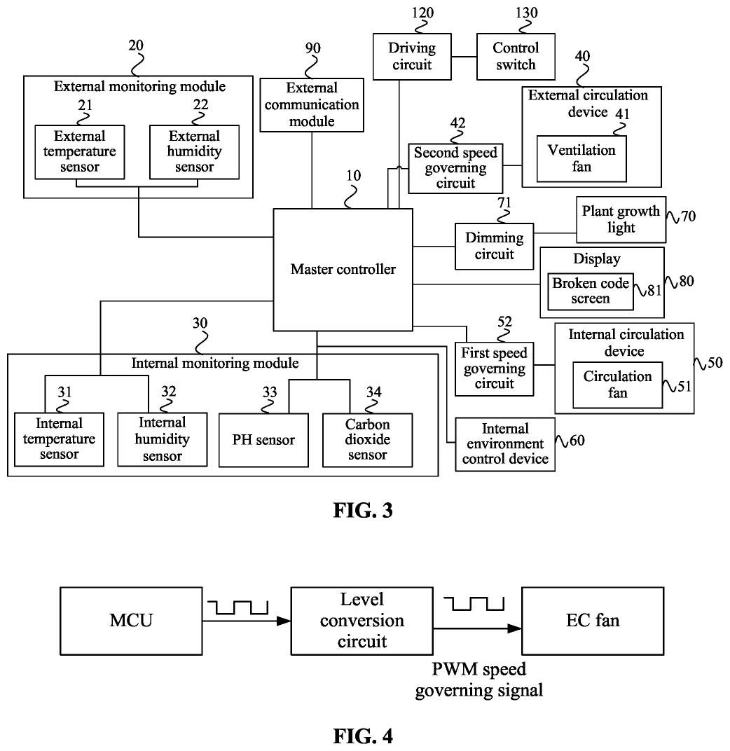

FIG. 3 is a structure diagram of another greenhouse plant growth monitoring system provided by an embodiment of the present disclosure. Referring to FIG. 3, the greenhouse plant growth monitoring system may also include a first speed governing circuit 52. The first speed governing circuit 52 is electrically connected between the internal circulation control signal output terminal and the control terminal of the internal circulation device 50. The first speed governing circuit 52 is configured to control an air outlet speed of the circulation fan 51 in the internal circulation device 50 according to an internal circulation adjustment signal provided by the master controller 10.

The first speed governing circuit 52 can achieve the adjustment of the rotation speed of the circulation fan 51 and is electrically connected between the internal circulation control signal output terminal and the control terminal of the internal circulation device 50. When the air speed of the circulation fan 51 in the internal circulation device 50 needs to be adjusted, the master controller 10 transmits the internal circulation adjustment signal to the first speed governing circuit 52 so as to adjust the magnitude of the air outlet speed of the circulation fan 51, and an air outlet intensity of the circulation fan 51 may be adaptively adjusted according to the environment.

Exemplarily, FIG. 5 is a diagram illustrating a working principle of a first speed governing circuit in a greenhouse plant growth monitoring system provided by an embodiment of the present disclosure. As shown in FIG. 5, the first speed governing circuit may include a level conversion circuit. In this case, a microcontroller unit (MCU) is built into the master controller. The MCU transmits the internal circulation adjustment signal to the level conversion circuit, the level conversion circuit converts the internal circulation adjustment signal to output a pulse width modulation (PWM) speed governing signal having a proper level, and the circulation fan 51 adjusts the rotation speed of the circulation fan 51 according to the received PWM speed governing signal to adjust the air outlet speed of the circulation fan.

Referring to FIG. 3, the greenhouse plant growth monitoring system may also include a second speed governing circuit 42. The second speed governing circuit 42 is electrically connected between the external circulation control signal output terminal and the control terminal of the external circulation device 40. The second speed governing circuit 42 is configured to control an air outlet speed of the ventilation fan 41 in the external circulation device according to an external circulation adjustment signal provided by the master controller 10.

The second speed governing circuit 42 can achieve the adjustment of the rotation speed of the ventilation fan 41 and is electrically connected between the external circulation control signal output terminal and the control terminal of the external circulation device 40. When the air speed of the ventilation fan 41 in the external circulation device 40 needs to be adjusted, the master controller 10 transmits the external circulation adjustment signal to the second speed governing circuit 42 so as to adjust the magnitude of the air outlet speed of the ventilation fan 41, and an air outlet intensity may be adaptively adjusted according to the environment. The ventilation fan may be an electrical commutation (EC) fan, i.e., a centrifugal fan using an EC motor.

Exemplarily, FIG. 4 is a diagram illustrating a working principle of a second speed governing circuit in a greenhouse plant growth monitoring system provided by an embodiment of the present disclosure. As shown in FIG. 4, the second speed governing circuit may include a level conversion circuit. In this case, an MCU is built into the master controller. The MCU transmits the external circulation adjustment signal to the level conversion circuit, the level conversion circuit converts the external circulation adjustment signal to output a PWM speed governing signal having a proper level, and the EC fan adjusts the rotation speed of the EC fan 51 according to the received PWM speed governing signal to adjust the air outlet speed of the EC fan.

The embodiments of the present disclosure provide a greenhouse plant growth monitoring system. The system includes a master controller, an external monitoring module, an internal monitoring module and an external circulation device. The external environment monitoring signal output from the external monitoring module and the internal environment monitoring signal output from the internal monitoring module are transmitted to the master controller, and the master controller controls the external circulation device to be turned on or off. The external circulation device achieves an external circulation of air in the plant growth greenhouse to circularly exchange the air in the plant growth greenhouse with external air. In the technical solution of the present disclosure, through the real-time monitoring of the external environment monitoring signal and the internal environment monitoring signal of the plant growth greenhouse by the master controller in real time, working states of the internal circulation device and the external circulation device are adjusted in a targeted manner to enable the greenhouse plants to grow healthily in a suitable environment, effectively improving the quality, overall yield and profitability of the greenhouse plants.

Referring to FIG. 3, the external monitoring module 20 includes an external temperature sensor 21 and an external humidity sensor 22. The external temperature sensor 21 is configured to monitor an external environment temperature of the greenhouse, and output an external temperature monitoring signal. The external humidity sensor 22 is configured to monitor an external environment humidity of the greenhouse, and output an external humidity monitoring signal. The internal monitoring module 30 includes an internal temperature sensor 31 and an internal humidity sensor 32. The internal temperature sensor 31 is configured to monitor an internal environment temperature of the greenhouse and output an internal temperature monitoring signal.

The internal humidity sensor 32 is configured to monitor an internal environment humidity of the greenhouse, and output an internal humidity monitoring signal. The external environment signal input terminal includes an external humidity signal input terminal and an external temperature signal input terminal. The internal environment signal input terminal includes an internal humidity signal input terminal and an internal temperature signal input terminal. The external temperature signal input terminal is electrically connected to the external temperature sensor 21, the external humidity signal input terminal is electrically connected to the external humidity sensor 22, the internal temperature signal input terminal is electrically connected to the internal temperature sensor 31, and the internal humidity signal input terminal is electrically connected to the internal humidity sensor 32. The master controller 10 is configured to control the external circulation device 40 or the internal circulation device 50 to turn on or off according to the external temperature monitoring signal, the external humidity monitoring signal, the internal temperature monitoring signal and the internal humidity monitoring signal.

The external temperature sensor 21 monitors the external environment temperature and outputs the external temperature monitoring signal in real time. The external humidity sensor 22 monitors the external environment humidity and outputs the external humidity monitoring signal in real time. The internal temperature sensor 31 monitors the internal environment temperature and outputs the internal temperature monitoring signal in real time. The internal humidity sensor 32 monitors the internal environment humidity and outputs the internal humidity monitoring signal in real time. The master controller 10 turns on or turns off the external circulation device 40 or the internal circulation device 50 according to the external temperature monitoring signal, the external humidity monitoring signal, the internal temperature monitoring signal and the internal humidity monitoring signal. The temperature sensor may monitor a state of a suitable temperature, a temperature above the suitable temperature or a temperature below the suitable temperature, and the humidity sensor may monitor a state of a suitable humidity, a humidity above the suitable humidity or a humidity below the suitable humidity.

Exemplarily, with the interior of a tent as the internal environment and the exterior of a tent as the external environment, the description is given by using turn-on and turn-off of the ventilation fan 41 as an example, referring to Table 1.

In a case where a tent internal temperature is above a suitable temperature and a tent internal humidity is any humidity, that is, the growth of the greenhouse plants is not affected by the humidity, if a tent external temperature is the suitable temperature and a tent external humidity is any humidity, the master controller 10 controls the ventilation fan in the external circulation device 40 to be turned on according to the internal temperature monitoring signal, the external temperature monitoring signal, the internal humidity monitoring signal and the external humidity monitoring signal. Thus, the ventilation fan 41 extracts the airflow from the interior of the tent to the exterior of the tent with a high power to exchange fresh air from the exterior of the tent to the tent, so that the tent internal temperature changes to the suitable temperature. In a case where the tent internal temperature is any temperature and the tent internal humidity is above the suitable humidity, that is, the growth of the greenhouse plants is not affected by the temperature, if the tent external temperature is any temperature and the tent external humidity is the suitable humidity, the master controller 10 controls the ventilation fan in the external circulation device 40 to be turned on according to the internal temperature monitoring signal, the external temperature monitoring signal, the internal humidity monitoring signal and the external humidity monitoring signal. Thus, the ventilation fan extracts the humid airflow from the interior of the tent to the exterior of the tent exchange the fresh air from the exterior of the tent to the tent. The internal circulation fan 51 accelerates the airflow circulation to reduce the humidity.

In the case where the tent internal temperature is above the suitable temperature, the tent internal humidity is the suitable humidity, if the tent external temperature is above the suitable temperature and the tent external humidity is any humidity, the ventilation fan 41 is in an off state. The master controller 10 also includes an alarm indication icon. The alarm indication icon is triggered to flash once the tent internal temperature, the tent internal humidity, the tent external temperature and the tent external humidity are all not suitable for the growth of the greenhouse plants or the ventilation fan 41 is continuously on for one hour, so as to remind managers to adjust and deal with this case in time. When the tent internal temperature is within a suitable temperature range and the tent internal humidity is within a suitable humidity range, the alarm is released.

TABLE 1

| Judgment | Interior of | Temperature | Above | Any | Above | Above | Suitable | Above suitable |
|---|---|---|---|---|---|---|---|---|
| factor | the tent | | suitable | temperature | suitable | suitable | temperature | temperature |
| | | | temperature | | temperature | temperature | | |
| | | Humidity | Any humidity | Above | Suitable | Above | Above | Above suitable |
| | | | | suitable | humidity | suitable | suitable | humidity |
| | | | | humidity | | humidity | humidity | |
| | Exterior | Temperature | Suitable | Any | Above | Above | Any | Suitable |
| | of the tent | | temperature | temperature | suitable | suitable | temperature | temperature |
| | | | | | temperature | temperature | | |
| | | Humidity | Any humidity | Suitable | Any | Suitable | Above | Above suitable |
| | | | | humidity | humidity | humidity | suitable | humidity |
| | | | | | | | humidity | |
| On-off state of ventilation fan | | | On | On | Off | On | Off | On |
| Alarm subsequent action | | | Alarm indication icon flashes when the fan does not stop after working for more than 1 hour | | | | | |
| Judgment | Interior of | Temperature | Below | Any | Below | Below | Any | Below suitable |
| factor | the tent | | suitable | temperature | suitable | suitable | temperature | temperature |
| | | | temperature | | temperature | temperature | | |
| | | Humidity | Any humidity | Below | suitable | Below | Below | Below suitable |
| | | | | suitable | humidity | suitable | suitable | humidity |
| | | | | humidity | | humidity | humidity | |
| | Exterior | Temperature | suitable | Any | Below | Below | Any | suitable |
| | of the tent | | temperature | temperature | suitable | suitable | temperature | temperature |
| | | | | | temperature | temperature | | |
| | | Humidity | Any humidity | suitable | Any | suitable | Below | Below suitable |
| | | | | humidity | humidity | humidity | suitable | humidity |
| | | | | | | | humidity | |

| | | | | | | |
|---|---|---|---|---|---|---|
| On-off state of ventilation fan | On | On | Off | On | Off | On |

| | |
|---|---|
| Subsequent alarm action | Alarm indication icon flashes when the fan does not stop after working for more than 1 hour |

The suitable temperature and the suitable humidity each have a setting range, where the suitable temperature is 20° C. to 28° C. and the suitable humidity is 35% to 75%. Referring to Table 2, the ventilation fan 41 works with a different fan intensity when the temperature or humidity is in a different interval range.

TABLE 2

| | | Relative | |
|---|---|---|---|
| Temperature | Fan intensity | humidity (RH) | Fan intensity |
| . . . | 100% | | |
| 13° C.-14° C. | 99% | | |
| 14° C.-15° C. | 87% | | |
| 15° C.-16° C. | 75% | 25%-27% | 100% |
| 16° C.-17° C. | 63% | 27%-29% | 83% |
| 17° C.-18° C. | 51% | 29%-31% | 66% |
| 18° C.-19° C. | 39% | 31%-33% | 49% |
| 19° C.-20° C. | 27% | 33%-35% | 32% |
| 20° C.-28° C. | Automatic | 35%-75% | Automatic |
| | (AUTO) Low | | (AUTO) Low |
| | Power Operation | | Power Operation |
| | (15%) | | (15%) |
| 28-29° C. | 27% | 75%-77% | 32% |
| 29-30° C. | 39% | 77%-79% | 49% |
| 30-31° C. | 51% | 79%-81% | 66% |
| 31-32° C. | 63% | 81%-83% | 83% |
| 32-33° C. | 75% | 83%-85% | 100% |
| 33-34° C. | 87% | | |
| 34-35° C. | 99% | | |
| . . . | 100% | | |

Referring to FIG. 3, the greenhouse plant growth monitoring system also includes an internal environment control device 60. The internal monitoring module 30 also includes at least one of a hydrogen ion concentration (PH) sensor 33 or a carbon dioxide sensor 34. The PH sensor is configured to monitor a PH value of the internal environment of the greenhouse and output a PH monitoring signal. The carbon dioxide sensor 34 is configured to monitor a carbon dioxide concentration of the internal environment of the greenhouse and output a carbon dioxide monitoring signal. The master controller 10 also includes an internal environment control signal output terminal. The internal environment signal input terminal also includes at least one of a PH signal input terminal or a carbon dioxide signal input terminal. The PH signal input terminal is communicatively connected to the PH sensor, the carbon dioxide signal input terminal is communicatively connected to the carbon dioxide sensor, and the internal environment control signal output terminal is connected to the internal environment control device 60. The master controller 10 is also configured to control the internal environment control device 60 to be turned on or off according to at least one of the PH monitoring signal or the carbon dioxide monitoring signal.

The PH sensor 33 in the internal monitoring module 30 can monitor the PH value of the internal environment of the greenhouse. In the growth process of the greenhouse plants, different PH environments also affect the growth of the plants. The PH environments mainly include an acidic environment, a neutral environment and an alkaline environment. In the practical monitoring process, a PH environment in the greenhouse is adjusted according to different adaptabilities of different plants to the PH environment. Moreover, the carbon dioxide sensor 34 in the internal monitoring module 30 can monitor the carbon dioxide concentration in the internal environment of the greenhouse. Carbon dioxide is a raw material for photosynthesis of the plants in the growth process, and appropriate increasing of the carbon dioxide concentration in the internal environment of the greenhouse can promote the growth speed of the plants. The carbon dioxide sensor 34 monitors the carbon dioxide concentration in the internal environment of the greenhouse in real time and transmits the carbon dioxide monitoring signal to the master controller 10 through a communication protocol. The PH monitoring signal in the internal environment of the greenhouse monitored by the PH sensor 33 is transmitted to the master controller 10 through the communication protocol. The master controller 10 controls the internal environment control device 60 to be turned on or off according to at least one of the PH monitoring signal or the carbon dioxide monitoring signal.

The internal environment control device 60 includes a humidity adjustment device, a temperature adjustment device, a carbon dioxide adjustment device, and a PH adjustment device. The humidity adjustment device may adjust the humidity magnitude of the internal environment of the greenhouse, the temperature adjustment device may adjust the temperature magnitude of the internal environment of the greenhouse, the carbon dioxide adjustment device may adjust the carbon dioxide concentration magnitude of the internal environment of the greenhouse, and the PH adjustment device may adjust the PH environment in the greenhouse. The PH environment in the greenhouse may be a PH environment of soil needed by the greenhouse plant growth or a PH environment of water or nutrient fluid for irrigating the greenhouse plants. The PH environment to be adjusted is not limited in this embodiment. Each of the number of humidity adjustment devices, the number of temperature adjustment devices, the number of carbon dioxide adjustment devices and the number of PH adjustment devices may be one or more. The number of the adjustment devices is not limited in this embodiment. Moreover, the humidity adjustment device may be a dehumidifier or a humidifier, and the temperature adjustment device may be a heater, a chiller, an air conditioner or the like. The adjustment device for the greenhouse is not limited in this embodiment.

Referring to FIG. 3, the greenhouse plant growth monitoring system also includes a plant growth light 70. The master controller 10 also includes a dimming signal output terminal. The dimming signal output terminal is electrically connected to a control terminal of the plant growth light 70. The master controller 10 is also configured to control a luminance of the plant growth light.

The light intensity magnitude affects the growth of the greenhouse plants. Different greenhouse plants have different needs for the light intensity. Especially at night, the light intensity of the internal environment of the greenhouse is weak and cannot fulfill conditions for photosynthesis of the greenhouse plants. The plant growth light 70 is mounted in the greenhouse tent, and the luminance of the plant growth light 70 is adjusted according to the light intensity needed by the plants. The dimming signal output terminal of the master controller 10 is electrically connected to a control terminal of the plant growth light 70. The master controller 10 controls the luminance of the plant growth light 70 according to a dimming signal.

The greenhouse plant growth monitoring system further includes a dimming circuit 71. The dimming circuit 71 is electrically connected between the dimming signal output terminal and the control terminal of the plant growth light 70. The dimming circuit 71 is configured to control the luminance of the plant growth light 70 according to the dimming signal provided by the master controller 10.

The dimming circuit 71 can achieve the adjustment of the luminance of the plant growth light 70 and is electrically connected between the dimming signal output terminal and the control terminal of the plant growth light 70. When it is necessary to adjust the luminance of the plant growth light 70 to adapt to the environment needed by the greenhouse plant growth, the master controller 10 transmits the dimming signal to the dimming circuit 71 to change the luminance of the plant growth light 70. The luminance of the plant growth light 70 may be dimmed or brightened, and the luminance change may be adaptively adjusted according to the needs of the plant growth.

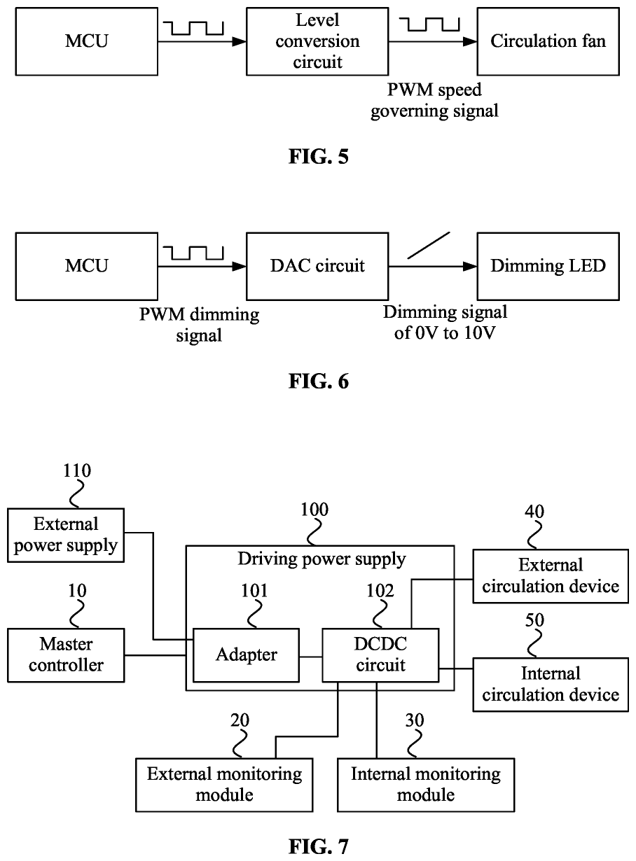

Exemplarily, FIG. 6 is a diagram illustrating a working principle of a dimming circuit in a greenhouse plant growth monitoring system provided by an embodiment of the present disclosure.

As shown in FIG. 6, the dimming circuit may include a digital to analog converter (DAC) circuit. The MCU is built into the master controller. The MCU transmits a PWM dimming signal to the DAC circuit. The DAC circuit can achieve a digital-to-analog signal conversion in which the PWM dimming signal is converted to a dimming signal of 0V to 10V, thereby adjusting a luminance of a dimming light-emitting diode (LED) in the plant growth light.

Referring to FIG. 3, the greenhouse plant growth monitoring system also includes a display 80. The master controller 10 also includes a display signal output terminal. The display signal output terminal is electrically connected to a control terminal of the display 80. The master controller 10 is also configured to control the display 80 for display.

The control terminal of the display 80 is electrically connected to the display signal output terminal of the master controller 10. The signal transmitted to the master controller 10 may be correspondingly display on the display 80. The display may be a liquid crystal display (LCD) or a light-emitting diode (LED) display. The type of the display is not limited in this embodiment. The display includes a broken code screen 81. The broken code screen 81 is a liquid crystal screen configured to display decimal digits. The broken code screen 81 may be a monochromatic broken code screen or a customized broken code screen. The type of the broken code screen is not limited in this embodiment. The display 80 may also display the humidity, the temperature, the pH and the carbon dioxide concentration in the internal environment of the greenhouse. Thus, in monitoring by the greenhouse plant growth monitoring system, it is convenient for the manager to know different humidity values, temperatures values, PH values and carbon dioxide concentration values at different times in the greenhouse environment in time.

Referring to FIG. 3, the greenhouse plant growth monitoring system also includes an external communication module 90. The master controller 10 also includes a communication signal receiving port. The communication signal receiving port is communicatively connected to an external terminal through the external communication module 90. The master controller 10 is also configured to receive a terminal control signal sent by the external terminal through the external communication module 90.

The external communication module 90 may achieve communication between an external terminal device and the master controller 10. The external terminal device may be a computer, a mobile phone or a tablet. Application (APP) software is installed in the external terminal device to achieve the communication between the external terminal device and the master controller 10 by means of a cloud server between the external communication module 90 and the external terminal device. The communication signal receiving port of the master controller 10 can receive the terminal control signal sent by the external terminal and received by the external communication module 90. The external terminal device can send a terminal control signal, and the external communication module 90 is disposed between the external terminal device and the master controller 10 to achieve the communication between the external terminal device and the master controller 10.

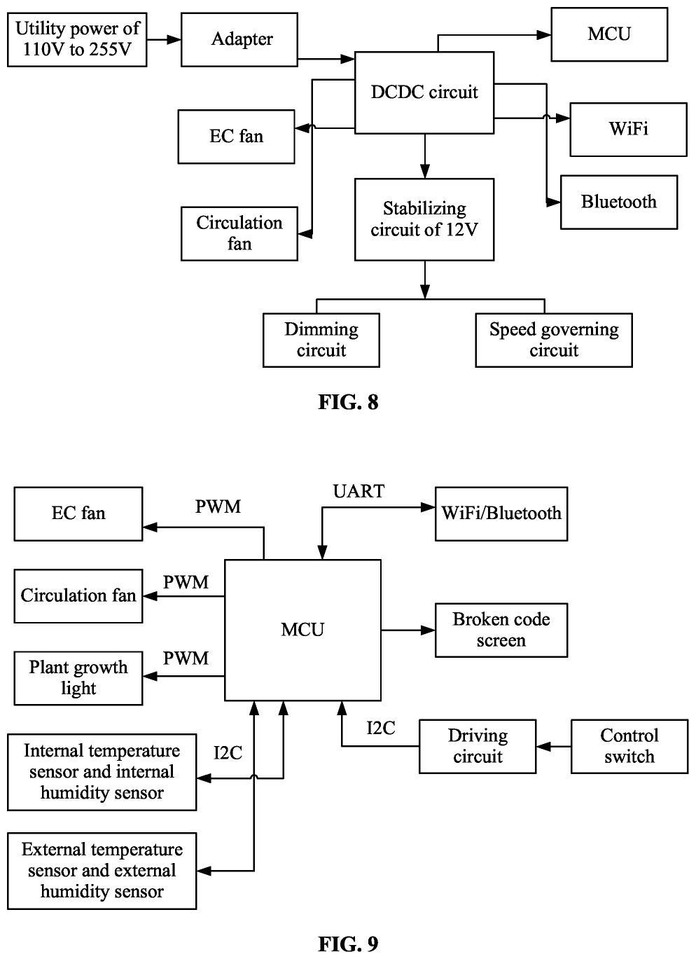

FIG. 7 is a structure diagram of another greenhouse plant growth monitoring system provided by an embodiment of the present disclosure. As shown in FIG. 7, the greenhouse plant growth monitoring system also includes a driving power supply 100. The master controller 10 also includes a power supply signal input terminal. The driving power supply 100 is electrically connected to the power supply signal input terminal, a power supply terminal of the external monitoring module 20, a power supply terminal of the internal monitoring module 30, a power supply terminal of the external circulation device 40, a power supply terminal of the internal circulation device 50 and an external power supply 110 separately. The driving power supply 100 is configured to convert a power supply signal provided by the external power supply 110 into a power supply source for each of the master controller 10, the external monitoring module 20, the internal monitoring module 30, the external circulation device 40 and the internal circulation device 50.

The driving power supply 100 may convert the power supply signal provided by the external power supply 110. For devices in a greenhouse plant growth system, different power supplies are needed by different devices and modules, and the driving power supply 100 correspondingly converts the unified power supply signal provided by the external power supply 110 into a power supply signal needed by each device and each module in the greenhouse plant growth system, thereby supplying power to the master controller 10, the external monitoring module 20, the internal monitoring module 30, the external circulation device 40 and the internal circulation device 50. In addition to providing power supply sources for the above-mentioned devices and modules, the driving power supply 100 may interconnect with and supply power to any module or device in the greenhouse plant growth system that needs to be powered. Exemplarily, the driving power supply 100 may provide a power supply source for each of the external communication module 90, the plant growth light 70 and the display 80, which is not limited in this embodiment. The external power supply 110 may be a single battery or consist of a battery pack, or may be a power supply directly provided by the power supply system. The type of the external power supply 110 is not limited in this embodiment.

Referring to FIG. 7, the driving power supply 100 of the greenhouse plant growth monitoring system includes an adapter 101 and a direct current-direct current (DCDC) circuit 102. An input terminal of the adapter 101 is electrically connected to the external power supply 110, and an output terminal of the adapter 101 is electrically connected to the DCDC circuit 102. The adapter 101 is configured to convert an alternating current power provided by the external power supply 110 into a direct current power. The DCDC circuit 102 is also electrically connected to the power supply signal input terminal, the power supply terminal of the external monitoring module 20, the power supply terminal of the internal monitoring module 30, the power supply terminal of the external circulation device 40 and the power supply terminal of the internal circulation device 50 separately. The DCDC circuit 102 is configured to convert the direct current power into the power supply source for each of the master controller 10, the external monitoring module 20, the internal monitoring module 30, the external circulation device 40 and the internal circulation device 50.

The external power supply 110 provides the alternating current power. The alternating current power is converted into the direct current power through the adapter 101. The direct current power is converted into the power supply source for each of the master controller 10, the external monitoring module 20, the internal monitoring module 30, the external circulation device 40 and the internal circulation device 50 through the DCDC circuit 102.

Exemplarily, FIG. 8 is a diagram illustrating a working principle of a driving power supply in a greenhouse plant growth monitoring system provided by an embodiment of the present disclosure. The external power supply may be utility power (having a voltage range of 110V to 255V). The external power supply transmits the power supply signal to the adapter 101 for conversion, thereby achieving the conversion from the alternating current power to the direct current power. The direct current power converted by the adapter is transmitted to the DCDC circuit, and the DCDC circuit may supply power to different devices and modules according to the magnitudes of different power supply voltages needed by the devices and modules. The DCDC circuit provides a supply voltage of 12V needed by the EC fan to the EC fan and provides a supply voltage of 12V needed by the circulation fan to the circulation fan, ensuring the EC fan and the circulation fan to normally work with the sufficient power supply. The DCDC circuit provides a supply voltage of 3.3V to the external communication module. The external communication module may include a WiFi module and a Bluetooth module. The DCDC circuit 102 may also provide a supply voltage to the master controller in which the MUC is disposed. Moreover, the DCDC circuit may also provide a needed voltage to the speed governing circuit and the dimming circuit. A voltage stabilizing circuit is disposed between the DCDC circuit and the speed governing circuit and between the DCDC circuit and the dimming circuit, and is used for providing a stable voltage of 12V for the speed governing circuit and the dimming circuit, ensuring the speed governing circuit and the dimming circuit to transmit the stable speed governing signal and dimming signal. The driving power supply supplies power to each module and device needed to be powered in the greenhouse plant growth system, ensuring the normal operation of the entire system.

Referring to FIG. 3, the greenhouse plant growth monitoring system also includes a driving circuit 120 and a control switch 130. The master controller 10 also includes a driving signal input terminal. A signal acquisition terminal of the driving circuit 120 is electrically connected to the control switch 130, and a driving signal output terminal of the driving circuit 120 is electrically connected to the driving signal input terminal. The driving circuit 120 is configured to acquire a control instruction of a user through the control switch 130 and drive the master controller 10 to work according to the control instruction.

When the user intends to turn on or turn off the greenhouse plant growth monitoring system, the control switch 130 in the control system can be used to achieve such intention. The control switch 130 determines information of a turn-on instruction after acquiring the control instruction of the user, the driving circuit 120 transmits a driving signal, and the master controller 10 starts to work after receiving the driving signal of the driving circuit 120.

On the basis of the preceding embodiments, the present disclosure also provides a specific implementation mode. FIG. 9 is a structure diagram of a master control circuit of a greenhouse plant growth monitoring system provided by an embodiment of the present disclosure. As shown in FIG. 9, in the practical application scenario, the user inputs the control instruction at the control switch according to usage needs, the driving circuit drives the MCU in the master controller to work after acquiring the control instruction of the user, and the MCU can control the output of the speed governing signals and the dimming signal according to multiple parameters and information values fed back by the internal temperature sensor, the internal humidity sensor, the external temperature sensor and the external humidity sensor. The air outlet speed of the EC fan can be controlled by the output PWM speed governing signal in the first path, the air outlet speed of the circulation fan can be controlled by the output PWM speed governing signal in the second path, and the luminance of the plant light can be adjusted by the output PWM dimming signal. The communication connection between the MCU and Wi-Fi or Bluetooth may also be achieved through a universal asynchronous receiver/transmitter (UART). The MCU may also output the display signal, the display signal is transmitted to the broken code screen of a display and multiple pieces of parameter information are presented on the break code screen, facilitating monitoring and viewing relevant information by the user in time.

What is claimed is:

1. A greenhouse plant growth monitoring system, comprising:
an external monitoring module, which is disposed outside a greenhouse and is configured to monitor an external environment of the greenhouse and output an external environment monitoring signal;
an internal monitoring module, which is disposed inside the greenhouse and is configured to monitor an internal environment of the greenhouse and output an internal environment monitoring signal;
an external circulation device, which is configured to control external circulation of air in the greenhouse for plant growth; and
a master controller, which comprises an external environment signal input terminal, an internal environment signal input terminal and an external circulation control signal output terminal, wherein the external environment signal input terminal is connected to an external monitoring signal output terminal of the external monitoring module; the internal environment signal input terminal is connected to an internal monitoring signal output terminal of the internal monitoring module; the external circulation control signal output terminal is electrically connected to a control terminal of the external circulation device; and the master controller is configured to control the external circulation device to be turned on or off according to the external environment monitoring signal and the internal environment monitoring signal.

2. The greenhouse plant growth monitoring system of claim 1, wherein the external monitoring module comprises an external temperature sensor and an external humidity sensor, wherein the external temperature sensor is configured to monitor an external environment temperature of the greenhouse and output an external temperature monitoring signal, and the external humidity sensor is configured to monitor an external environment humidity of the greenhouse and output an external humidity monitoring signal;
wherein the internal monitoring module comprises an internal temperature sensor and an internal humidity sensor, wherein the internal temperature sensor is configured to monitor an internal environment temperature of the greenhouse and output an internal temperature monitoring signal, and the internal humidity sensor is configured to monitor an internal environment humidity of the greenhouse and output an internal humidity monitoring signal;
wherein the external environment signal input terminal comprises an external humidity signal input terminal and an external temperature signal input terminal; and the internal environment signal input terminal comprises an internal humidity signal input terminal and an internal temperature signal input terminal, wherein the external temperature signal input terminal is electrically connected to the external temperature sensor, the external humidity signal input terminal is electrically connected to the external humidity sensor, the internal temperature signal input terminal is electrically connected to the internal temperature sensor, and the internal humidity signal input terminal is electrically connected to the internal humidity sensor; and
wherein the master controller is configured to control the external circulation device to be turned on or off according to the external temperature monitoring signal, the external humidity monitoring signal, the internal temperature monitoring signal and the internal humidity monitoring signal.

3. The greenhouse plant growth monitoring system of claim 2, further comprising:
an internal environment control device,
wherein the internal monitoring module further comprises at least one of a hydrogen ion concentration (PH) sensor or a carbon dioxide sensor; the PH sensor is configured to monitor a PH value of the internal environment of the greenhouse and output a PH monitoring signal; the carbon dioxide sensor is configured to monitor a carbon dioxide concentration of the internal environment of the greenhouse and output a carbon dioxide monitoring signal; and
wherein the master controller further comprises an internal environment control signal output terminal; the internal environment signal input terminal further comprises at least one of a PH signal input terminal or a carbon dioxide signal input terminal; the PH signal input terminal is communicatively connected to the PH sensor, the carbon dioxide signal input terminal is communicatively connected to the carbon dioxide sensor, and the internal environment control signal output terminal is connected to the internal environment control device; and the master controller is further configured to control the internal environment control device to be turned on or off according to at least one of the PH monitoring signal or the carbon dioxide monitoring signal.

4. The greenhouse plant growth monitoring system of claim 3, wherein the internal environment control device comprises at least a humidity adjustment device, a temperature adjustment device, a carbon dioxide adjustment device, and a PH adjustment device.

5. The greenhouse plant growth monitoring system of claim 1, further comprising:
an internal circulation device, wherein the master controller further comprises an internal circulation control signal output terminal, wherein the internal circulation control signal output terminal is electrically connected to a control terminal of the internal circulation device; the master controller is further configured to control the internal circulation device to be turned on or off according to the external environment monitoring signal and the internal environment monitoring signal.

6. The greenhouse plant growth monitoring system of claim 5, further comprising:
a first speed governing circuit, wherein the first speed governing circuit is electrically connected between the internal circulation control signal output terminal and the control terminal of the internal circulation device; and the first speed governing circuit is configured to control an air outlet speed of a circulation fan in the internal circulation device according to an internal circulation adjustment signal provided by the master controller.

7. The greenhouse plant growth monitoring system of claim 1, wherein the external circulation device comprises a ventilation fan.

8. The greenhouse plant growth monitoring system of claim 7, further comprising:
a second speed governing circuit, wherein the second speed governing circuit is electrically connected between the external circulation control signal output terminal and the control terminal of the external circulation device; and the second speed governing circuit is configured to control an air outlet speed of the ventilation fan in the external circulation device according to an external circulation adjustment signal provided by the master controller.

9. The greenhouse plant growth monitoring system of claim 1, further comprising:
a plant growth light, wherein the master controller further comprises a dimming signal output terminal; the dimming signal output terminal is electrically connected to a control terminal of the plant growth light; and the master controller is further configured to control a luminance of the plant growth light.

10. The greenhouse plant growth monitoring system of claim 9, further comprising:
a dimming circuit, wherein the dimming circuit is electrically connected between the dimming signal output terminal and the control terminal of the plant growth light; the dimming circuit is configured to control the luminance of the plant growth light according to a dimming signal provided by the master controller.

11. The greenhouse plant growth monitoring system of claim 1, further comprising:
a display, wherein the master controller further comprises a display signal output terminal; the display signal output terminal is electrically connected to a control terminal of the display; and the master controller is further configured to control the display to display.

12. The greenhouse plant growth monitoring system of claim 11, wherein the display comprises a broken code screen.

13. The greenhouse plant growth monitoring system of claim 1, further comprising:
an external communication module, wherein the master controller further comprises a communication signal receiving port; the communication signal receiving port is communicatively connected to an external terminal through the external communication module;
and the master controller is further configured to receive, via the external communication module, a terminal control signal transmitted by the external terminal.

14. The greenhouse plant growth monitoring system of claim 5, further comprising:
a driving power supply, wherein the master controller further comprises a power supply signal input terminal; the driving power supply is electrically connected to the power supply signal input terminal, a power supply terminal of the external monitoring module, a power supply terminal of the internal monitoring module, a power supply terminal of the external circulation device, a power supply terminal of the internal circulation device and an external power supply separately;
and the driving power supply is configured to convert a power supply signal provided by the external power supply into a power supply source for the internal circulation device, the external circulation device, the internal monitoring module, the external monitoring module and the master controller.

15. The greenhouse plant growth monitoring system of claim 14, wherein the driving power supply comprises an adapter and a direct current-direct current (DCDC) circuit,
wherein an input terminal of the adapter is electrically connected to the external power supply, and an output terminal of the adapter is electrically connected to the DCDC circuit; and the adapter is configured to convert an alternating current power provided by the external power supply into a direct current power; and
the DCDC circuit is further electrically connected to the power supply signal input terminal, the power supply terminal of the external monitoring module, the power supply terminal of the internal monitoring module, the power supply terminal of the external circulation device and the power supply terminal of the internal circulation device separately; and the DCDC circuit is configured to convert the direct current power into the power supply source for the internal circulation device, the external circulation device, the internal monitoring module, the external monitoring module and the master controller.

16. The greenhouse plant growth monitoring system of claim 1, further comprising:
a driving circuit and a control switch, wherein the master controller further comprises a driving signal input terminal; a signal acquisition terminal of the driving circuit is electrically connected to the control switch, and a driving signal output terminal of the driving circuit is electrically connected to the driving signal input terminal; and the driving circuit is configured to acquire a control instruction of a user through the control switch and drive the master controller to work according to the control instruction.
